(19) United States
(12) Patent Application Publication
(10) Pub. No.: US 2013/0117288 A1
(43) Pub. Date: May 9, 2013

(54) DYNAMICALLY TYPED QUERY EXPRESSIONS

(71) Applicants: Bart De Smet, Bellevue, WA (US); Henricus Johannes Maria Meijer, Mercer Island, WA (US); Brian Beckman, Newcastle, WA (US)

(72) Inventors: Bart De Smet, Bellevue, WA (US); Henricus Johannes Maria Meijer, Mercer Island, WA (US); Brian Beckman, Newcastle, WA (US)

(73) Assignee: MICROSOFT CORPORATION, Redmond, WA (US)

(21) Appl. No.: 13/291,102

(22) Filed: Nov. 8, 2011

(51) Int. Cl. G06F 17/30; G06F 7/00

(52) U.S. Cl. 707/756; 707/803; 707/E17.062; 707/E17.044

(57) ABSTRACT

A dynamic call on dynamic data can be transformed into a dynamic call on a structure representing dynamic data. Specifically, a dynamic query with a code object representation that includes an untyped parameter can be transformed into a dynamic query with a function call with a dynamic meta-object. The function call with the dynamic meta-object tracks operation(s) that correspond to the code object representation that includes an untyped parameter in order to build a structure representing such code object representation. At runtime, the dynamic query is built and the structure representing the code object representation is rebuilt so as to enable a dynamic query with a code object representation that references untyped data.

### BACKGROUND

Some general-purpose programming languages, including C#® and Visual Basic®, support dynamic typing using a “dynamic” keyword. This keyword can be utilized as a type to create statically typed objects that bypass compile-time checks, for example in programming languages that support both static and dynamic typing. In other words, an object can be statically typed as a dynamic type. At compile time, an element that is typed as dynamic is assumed to support substantially any operation. However, if the code is not valid, errors are reported at run time.

Expression trees, a type of code object representation, represent code as data in a tree-like structure, where each node of a tree corresponds to an expression (e.g., method call, binary operation (e.g., x<y) . . . ) or portion thereof. Code represented by expression trees can be compiled and run to enable dynamic modification of executable code, the execution of language integrated query (LINQ) queries, and the creation of dynamic queries. Compilers associated with general-purpose programming languages can create an expression tree automatically based on a lambda expression, for example, or the expression trees can be created manually.

Language-integrated query (LINQ), and supporting technology, provide convenient and declarative shorthand query syntax (e.g., SQL-like) to facilitate specification of queries within a programming language (e.g., C#®, Visual Basic® . . . ). More specifically, query operators are provided that map to low-level language constructs or primitives such as methods and lambda expressions. Query operators are provided for various families of operations (e.g., filtering, projection, joining, grouping, ordering . . . ), and can include but are not limited to “where” and “select” operators that map to methods that implement the operators that these names represent.

In LINQ, expression trees are used to represent structured queries that target sources of data that implement a particular interface, such as “IQueryable<T>.” For example, the LINQ to Structured Query Language (SQL) provider implements “IQueryable<T>” for querying relational data stores. General-purpose programming-language compilers compile queries that target such data sources into code that builds an expression tree at runtime. The query provider can then traverse the expression tree and translate it into a query language supported by the data source.

### SUMMARY

The following presents a simplified summary in order to provide a basic understanding of some aspects of the disclosed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the subject disclosure generally pertains to dynamically typed query expressions. A dynamic call on dynamic data can be transformed into a dynamic call on a structure representing the dynamic data. In one particular embodiment, a dynamic query and corresponding code object representation (e.g., an expression tree, among others) that includes an untyped parameter can be transformed into a function call with a dynamic meta-object. The dynamic query is transformed into at least one function call in which each function call is made with a dynamic meta-object that records an operation corresponding to the dynamic data (e.g., code object representation or expression tree that references untyped data). Since the dynamic meta-object records each operation corresponding to dynamic data, the structure that includes the function call with the dynamic meta-object can be reconstructed at runtime to represent the dynamic data, and in particular, the code object representation that includes an untyped parameter.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

FIG. 1 is a block diagram of a dynamic querying system.

FIG. 2 is a block diagram of dynamic querying system for untyped data.

FIG. 3 is an exemplary dynamic query with an expression tree that includes at least one untyped parameter.

FIG. 4 is an exemplary untyped expression tree that is transformed into a structure representing the untyped expression tree.

FIG. 5 is a flow chart diagram of a method of transforming a dynamic call on dynamic data.

FIG. 6 is a flow chart diagram of a method of transforming a dynamic query with an untyped expression tree.

FIG. 7 is a flow chart diagram of a method creating a structure representative of an untyped expression tree for employment in a query at runtime.

FIG. 8 is a schematic block diagram illustrating a suitable operating environment for aspects of the subject disclosure.

### DETAILED DESCRIPTION

Details below are generally directed toward dynamically typed query expressions and in particular, dynamic querying of untyped data with a programming language. In general, a dynamic query (e.g., query over dynamically typed data) that operates with an untyped code object representation is translated into a dynamic query of a function call in which the function call is injected with a dynamic meta-object. The dynamic query and function with a dynamic meta-object allows a reconstruction of a code object representation that includes an untyped parameter at runtime to enable dynamic code object representation and, in turn, runtime execution of code object representations that reference untyped data (e.g., untyped code object representations). Conventionally, a programming language may not allow untyped code object representations to be employed dynamically but rather require strong typing (e.g., mapping to a static and/or local element) or mapping to a database schema that is known in order to allow a compiler to resolve a code object representation. Thus, conventional techniques will fail (e.g., generate an error) in regards to compiling a programming language that include an untyped code object representation and a dynamic operation.

Various aspects of the subject disclosure are now described in more detail with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

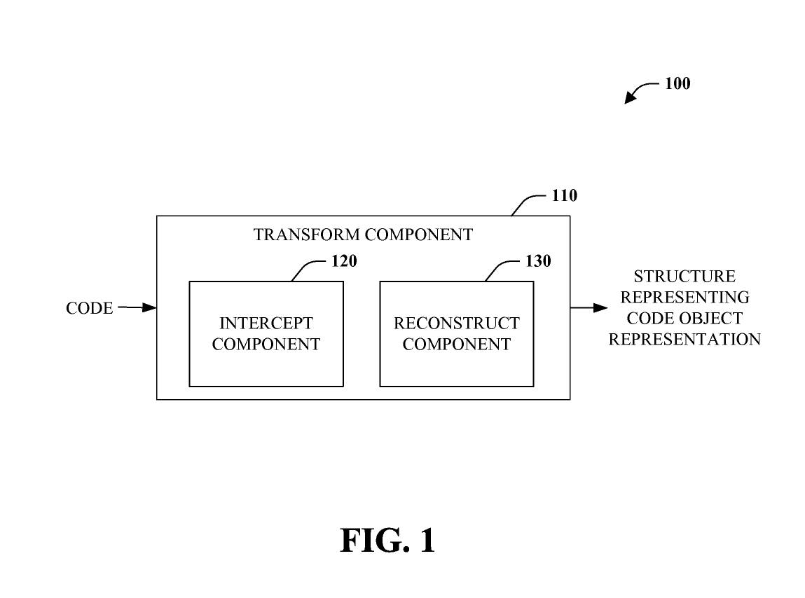

Referring initially to FIG. 1, a dynamic query system 100 is illustrated. The dynamic querying system 100 includes a transform component 110 that handles any dynamic call on data that is untyped or includes a dynamic parameter. In particular, the transform component 110 can handle a dynamic query with a code object representation that includes a dynamic parameter. It is to be appreciated that the code object representation can be, but is not limited to, an expression tree, among others. In other words, a dynamic query can be performed with a code object representation (e.g., an expression tree) that references dynamic data. It is to be appreciated that “dynamic call” and “dynamic query” refer to a call or query on data from a data source to which a schema is unknown. The transform component 110 is configured to deconstruct the dynamic query (e.g., dynamic call) with the untyped code object representation (e.g., untyped data or dynamic data) into a structure representative of the code object representation such that the dynamic query can be executed on the structure without a compile-time type-checking error. In general, the transform component 110 generates a structure representing the untyped data (e.g., an expression tree that references untyped data, a code object representation that references untyped data) to enable a dynamic call (e.g., querying, among others) of such structure. Thus, a general-purpose programming language can perform a dynamic call on dynamic data with the transform component 110. Moreover, at runtime, the untyped data (e.g., code object representation that includes an untyped parameter that references untyped data, expression tree that includes an untyped parameter that references untyped data, among others) can be reconstructed based upon the structure, and the dynamic query can be built and subsequently executed based on the reconstructed code object representation.

Conventionally, an error will be produced for a dynamic call on dynamic data. In particular, an error will be generated if an expression tree or other code object representation references any untyped or dynamic data or operation. In other words, a dynamic query with an expression tree or code object representation is typically handled as long as the expression tree or code object representation and all included parameters are strongly typed (e.g., static) or mapped to a data source. In another example, the dynamic query with an untyped expression tree (e.g., an expression tree that includes an untyped parameter that references untyped data) can be handled if the schema (e.g., a schema for a data source that is unknown at runtime) is known for the data source. However, since the dynamic query with the expression tree includes a parameter that is not typed and the data source schema is not known, an error will result with conventional techniques.

Stated differently, a query provider can traverse the code object representation structure and translate it into a query language supported by the data source. However, if the data source does not have a schema or the schema is not known, code object representations that include a dynamic (e.g., untyped) parameter will generate an error. For example, a dynamic query with an expression tree referencing dynamic data will fail. In other words, there cannot be a LINQ query over a variable of dynamic type in the case that the strong type of the elements of the source (e.g., collection or database) is unknown.

By way of example and not limitation, the subject disclosure includes various examples and discussions that include an expression tree as an exemplary code object representation. However, it is to be appreciated that the code object representation can be any suitable code object that includes untyped data or references untyped data. Furthermore, the subject disclosure is not to be limited to an expression tree as a code object representation. Described herein, an expression tree is just one of various code object representations that exist and is used solely as an example. In other words, the use of “expression tree” can also be referred to as a “code object representation” throughout the subject disclosure.

Continuing with FIG. 1, the transform component 110 includes an intercept component 120. The intercept component 120 can be configured to capture a portion of code that is a dynamic call on dynamic data, and in particular a dynamic query with a code object representation that includes an untyped parameter. In general, the intercept component 120 can handle any suitable programming-language code that includes a dynamic code object representation (e.g., a code object representation that includes at least one untyped parameter or operation that references untyped data, an expression tree that includes at least one untyped parameter or operation that references untyped data, among others). Based at least in part upon the intercept component 120, a reconstruct component 130 can be configured to generate a structure representing the captured portion of code. In particular, by transforming the intercepted code object representation into a representative structure, the dynamic query with a code object representation that includes an untyped parameter is translated into a dynamic query on a structure representing the code object representation. Thus, a general-purpose programming-language compiler need not generate an error since the dynamic query is with the structure representing the code object representation rather than with the code object representation that includes an untyped parameter.

The intercept component 120 can be configured to identify any dynamic to dynamic function call in order to implement a transformation. In particular, the dynamic to dynamic call can be a dynamic query to an expression tree (e.g., a code object representation) that includes a dynamic parameter or operation (e.g., dynamic query to an expression tree that includes an untyped parameter that references untyped data). The reconstruct component 130 can be configured to generate a structure representing the expression tree, wherein the structure can include a function call with a dynamic meta-object (discussed in more detail below). In general, the expression tree that references untyped data is represented by a structure that includes function call(s) with respective dynamic meta-objects in order to track any operations performed based upon the expression tree.

For example, consider the following exemplary query that seeks to retrieve names of products “p” whose price exceeds one hundred dollars:
source.Where(p=>p.Price>100).Select(p=>p.Name)
   Conventional techniques handling the above dynamic query will fail since the dynamic query is with an expression tree (e.g., a code object representation) that includes a dynamic operation or parameter. However, the transform component 110 can be configured to intercept this call (e.g., dynamic query with an expression tree that references dynamic data) and generate a structure that represents the expression tree in which the structure includes a function call with a dynamic meta-object for each function call (e.g., here, Where and Select) associated with the dynamic query. More particularly, a call is made by an interceptor to the predicate passed to “Where.” In other words, “p=>p.Price>100” is invoked with “p” substituted for a dynamic meta-object. The selector function (e.g., “p=>p.Name”) of “Select” is invoked in a similar fashion. The generated structure further enables the dynamic query to be executed without a compile-time error. Moreover, the structure representing the expression tree can be reconstructed at runtime to build the expression tree that includes an untyped parameter.

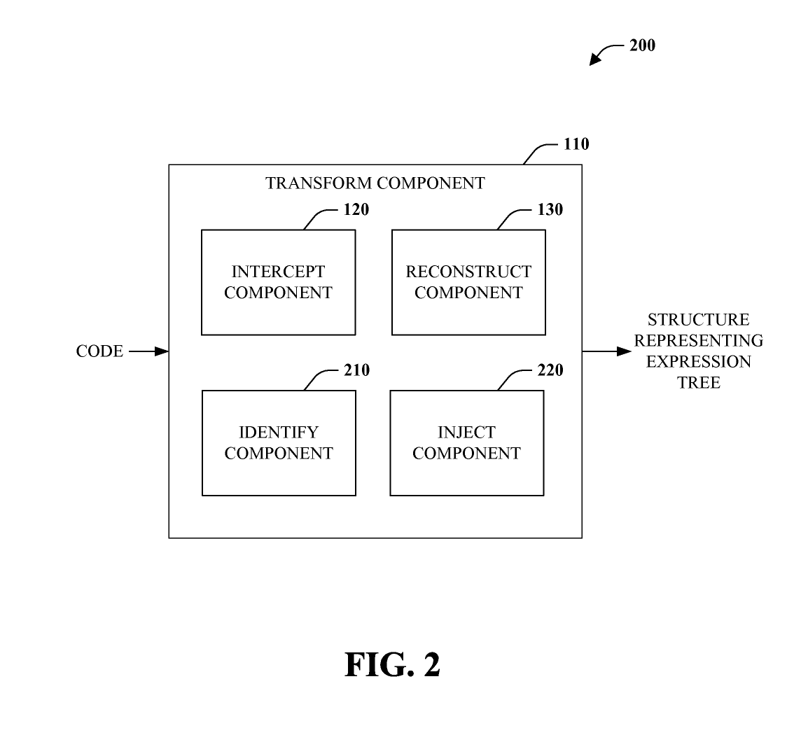

FIG. 2 illustrates a dynamic querying system 200 for untyped data, and in particular, expression trees that include at least one parameter that is untyped. The dynamic querying system 200 includes the transform component 110 that can be configured to generate a structure representing an expression tree (e.g., a code object representation) that includes an untyped parameter or untyped operation in order to enable a query with a dynamic portion of data. Generally, the intercept component 120 can be configured to capture a first dynamic call/method with a second dynamic call/method in which the reconstruct component 130 can be configured to create a structure representative of the second dynamic call/method. In particular, the intercept component 120 can be configured to collect a dynamic query with an expression tree that includes at least one dynamic parameter. Since the reconstruct component 130 generates a structure representative of the expression tree (which references a dynamic, untyped data), the dynamic query on the structure can be handled and executed without a compile-time error.

The dynamic querying system 200 further includes an identify component 210 that can be configured to identify function(s) associated with the expression tree represented by the structure. Following the example above, a function of “Select” and a function of “Where” can be identified. It is to be appreciated that the identify component 210 can locate any suitable number of functions associated with a dynamic query with an expression tree that includes untyped parameter(s) or untyped operation(s).

Based on the identify component 210, an inject component 220 can be configured to make each function call with a respective dynamic meta-object. For instance, following the discussed example, a call can be made to the predicate, “p=>p.Price>100,” passed to “Where,” with a dynamic meta-object substituted for “p”. The selector function (e.g., “p=>p.Name”) of “Select” can be invoked in a like manner. The inject component 220 can be configured to generate dynamic meta-object(s) for the function calls within a dynamic query with an expression tree that includes an untyped parameter that references untyped data (e.g., also referred to as an untyped expression tree) in order to record and track any operation associated with such untyped expression tree. In general, the dynamic meta-object records each operation that is included with the expression tree. It is to be appreciated that the dynamic meta-object can track any suitable number of operations corresponding to an expression tree for a function call regardless of the number of operations and/or a type of operation (e.g., greater than, less than, among others). Moreover, as discussed in more detail below, a “GetEnumerator” can trigger a termination of a recording or a tracking of operations to include with a dynamic meta-object.

Consider again the following portion of code as discussed above:
source.Where(p=>p.Price>100).Select(p=>p.Name)
   As previously mentioned, conventional general-purpose programming languages, and more specifically respective compilers, would generate an error for the above code. However, the above can be intercepted by the intercept component 120 based upon being a dynamic query with an expression tree that references at least one dynamic or untyped parameter. Once captured, the reconstruct component 130 can utilize the identify component 210 and the inject component 220 in order to generate a structure representative of the expression tree. In particular, the identify component 210 can ascertain each function call associated with the dynamic query with the expression tree. Here, the identify component 210 can identify the “Where” function and the “Select” function. The inject component 220 can make the identified function calls with a respective dynamic meta-object. In general, the transform component 110 will reconstruct the above portion of code to the following:
source.Where(dynamic_meta_object1).Select(dynamic_meta_object2)
   By transforming the dynamic query with an expression tree to a dynamic query with at least one function call with a dynamic meta-object, the expression tree is represented by a structure that does not result in a compile-time error.

By way of example and not limitation, the dynamic querying system 200 can include any suitable library, dynamic library, provider, dynamic provider, among others. In particular, the transform component 110 can employ any suitable dynamic library (not shown) and/or dynamic provider (not shown) in which to enable the function call with the dynamic meta-object to collect and track any operation associated with the expression tree being represented. Furthermore, the transform component 110 can include any suitable dynamic bindings (not shown) in order for the dynamic meta-object for each function call to execute at runtime in order to collect any suitable operation corresponding to the expression tree being represented by a structure.

Moreover, it is to be appreciated that the generated structure representing the dynamic data can be compiled during any time to reconstruct the dynamic data. In particular, a structure representing an expression tree that includes an untyped parameter can be reconstructed at any time in order to create the expression tree. For instance, a “.Compile” can be executed on the structure in order to generate the original expression tree.

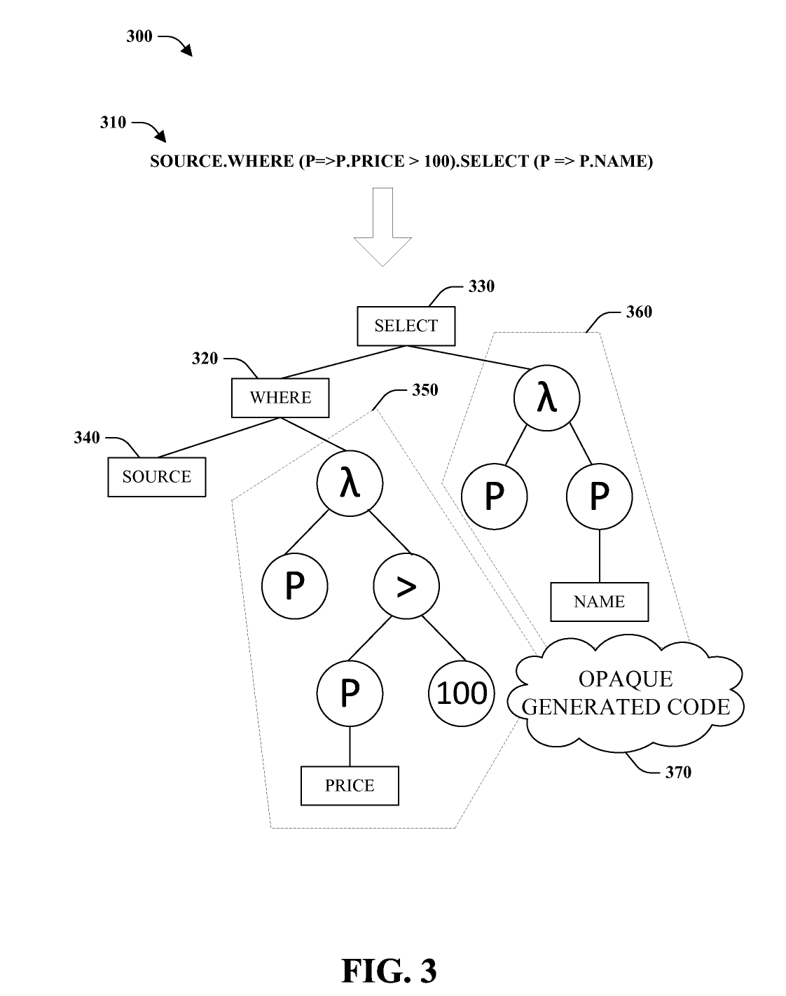

FIG. 3 illustrates an exemplary dynamic query with an untyped expression tree 300. The exemplary dynamic query with an untyped expression tree (e.g., a code object representation) 300 can be a dynamic call on dynamic data 310 (e.g., “SOURCE”) that is depicted as a first function “Where” 320 with a first expression tree 350 and a second function “Select” 330 with a second expression tree 360 that are to be executed on a source 340. In general, FIG. 3 illustrates the difference between an expression tree and delegates. For instance, if you have an expression tree, there is a lambda expression for each function in which untyped data exists. However, if the first expression tree 350 and the second expression tree 360 can be transformed into a first delegate and a second delegate (e.g., utilizing the transform component 110, for example), the first delegate and the second delegate can be executed since such delegates are seen by a compiler as opaque generated code. In other words, since the transform component 110 translates untyped data (e.g., expression tree that references at least one portion of untyped data) into delegates (e.g., a structure representing the expression tree), the general-purpose programming language compiler will treat the structure as input/output (I/O).

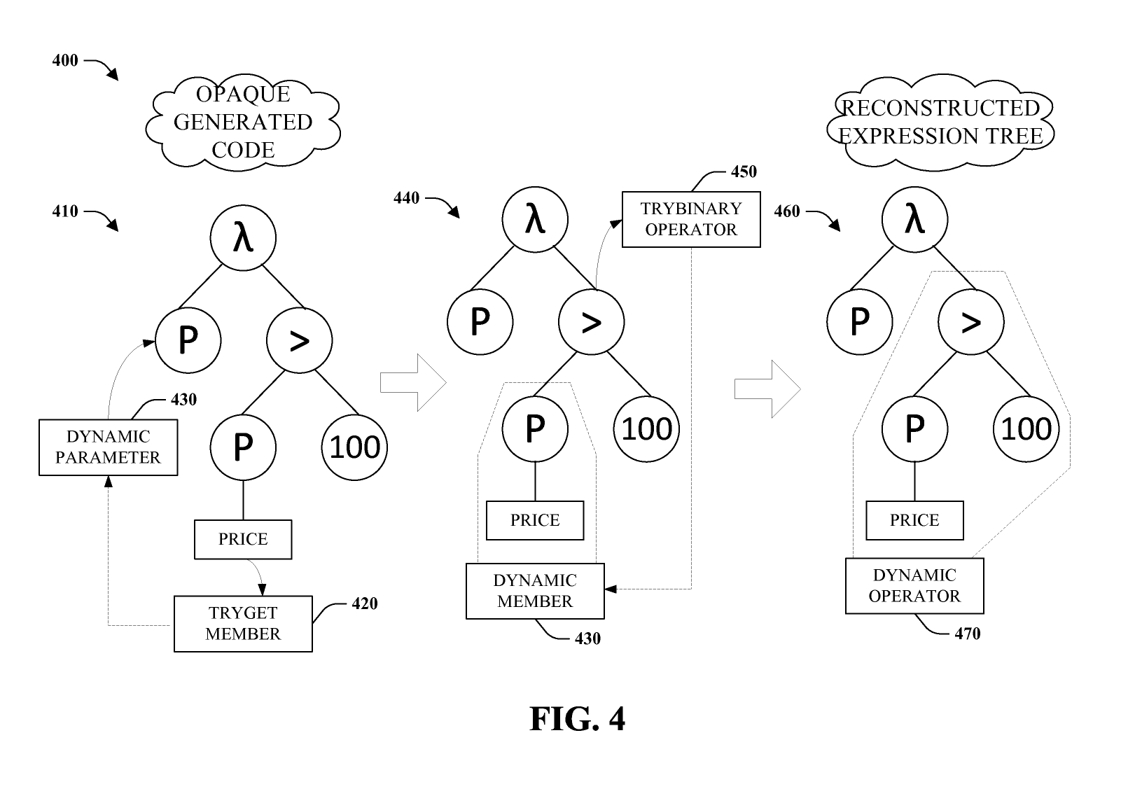

Continuing to FIG. 4, an exemplary untyped expression tree 400 is transformed into a structure representing the untyped expression tree (e.g., an expression tree that includes an untyped parameter or untyped operation). In general, the exemplary untyped expression tree 400 includes a first predicate (e.g., function call “Where”) and utilizes a dynamic meta-object to create a structure representing the untyped data which is, in this case, an expression tree that references untyped data.

Take, for instance, the above discussed example as follows:
source.Where(p=>p.Price>100).Select(p=>p.Name)
   The dynamic call on dynamic data can include a first predicate (e.g., function call “Where”) and a second predicate (e.g., function call “Select”). The predicate or function call “Where” is discussed in more detail with particular aspects of the subject disclosure. The following explanation of function “Where” is not to be limiting on the subject disclosure and is discussed solely for exemplary purposes. For instance, it is to be appreciated that any suitable function call can be employed as well as any number of function calls dependent upon the dynamic call on dynamic data.

An expression tree, here representing a lambda expression, can reference dynamic data in which a structure representative thereof is to be generated. At reference numeral 410, the expression tree is depicted. Based upon an invocation of the lambda expression, a structure representing the expression tree can be created. A dynamic parameter 430 (also referred to as a dynamic meta-object) is passed to the “Where” predicate. The dynamic parameter 430 can record and track any operation associated with the expression tree. For instance, a “TryGetMember” operation is recorded with the dynamic parameter 430 based upon inclusion with the expression tree. At reference numeral 440, the dynamic member 430 continues to record an operation corresponding to the expression tree. For example, a “TryBinaryOperation” is recorded into the dynamic member 430. At reference numeral 460, the operations from the expression tree are included with a dynamic operator 470 that is a structure representing the expression tree. It is to be appreciated that the above can be implemented for each predicate and/or function call associated with the dynamic call on dynamic data. For example, a dynamic operator can be additionally constructed for the predicate or function call “Select.”

The following is high-level discussion of an exemplary generation of a representation of an untyped data to which a dynamic call is made. In other words, the following is a high-level discussion of a dynamic query with an untyped expression tree that can be carried out by the transform component 110.

The “IQueryable<T>” and/or “IQbservable<T>” interfaces can be employed to build a data representation of a query expression that can be translated into a target query language (e.g., Transact-SQL (T-SQL), Common Information Model Query Language, among others) at runtime. For reference, the “IQueryable<T>” interface is depicted as follows:

```
interface IQueryable<T>
{
    Expression Expression { get; }
    Type ElementType { get; }
    IQueryProvider Provider { get; }
}
interface IQueryProvider
{
    IQueryable<T> CreateQuery<T>(Expression expression);
}
```

Extension methods are provided on “IQueryable<T>” and “IQbservable<T>” which allow users to formulate a query against a source represented by the interface implementation and instance thereof For instance, operators can include “Where,” “Select,” among others and depend on the generic parameter “T” of the interface. For instance, take the following:

static IQueryable<T> Where<T>(this IQueryable<T> source,
Expression<Func<T, bool>> predicate);

The “Expression<TDelegate>” is utilized for the predicate which triggers the compiler to emit an expression tree code-as-data representation of the function that is passed in as a lambda expression.

By way of example and not limitation, a data source can be queried in which the data source does not have a proper schema (e.g., no mapping onto a static element type “T” can be achieved). Using a programming language feature of dynamic typing, the following can be written (e.g., assuming a concrete implementation of “IQueryable<T>” exists):

IQueryable<dynamic> source = null;
var res = source.Where(d => d.Foo == 42);

Unfortunately, as discussed, the above fails to compile stating that an expression tree may not contain a dynamic operation.

For example, a SQL database can be queried whose schema is unknown. Yet, it is known to be connected to a table containing products with columns called Name and Price. It can be desired to write the following and have it compile down to T-SQL:

```
IQueryable<dynamic> products = ...;
    var res = (from p in products
            where p.Price > 100
            orderby p.Price descending
            select new { p.Name, p.Price })
            .Take(10);
foreach (var p in res)
    Console.WriteLine(p.Name + “ costs ” + p.Price);
```

All of the query expression clauses here turn into lambda expressions assigned to expression tree based parameters, which fail to compile because of the restriction mentioned above (e.g., dynamic call with an expression tree that includes an untyped parameter).

Unfortunately, there can be many scenarios that require dynamic queries because the data returned by the queries are untyped. For example, most REST services are loosely typed, or have a very complex schema.

In order to allow queries over dynamically typed collections to be formulated and yet be inspectable by query providers at runtime, an “IQueryableDynamic interface” is discussed with an associated expression tree model. Take the following portion of code associated with the “IQueryableDynamic interface”:

```
interface IQueryableDynamic
{
    DynamicExpression Expression { get; }
    IQueryProviderDynamic Provider { get; }
    IEnumerator<dynamic> GetEnumerator( );
}
interface IQueryProviderDynamic
{
    IQueryableDynamic CreateQuery(DynamicExpression expression);
}
```

Compared to the original IQueryable” counterparts, the above differ in the erasure of the generic type parameter and its substitution for “dynamic.” The reason for providing a “GetEnumerator” method rather than implementing the “IEnumerable<dynamic>interface” is because the language does not allow such an interface implementation either. Alternatively, an operator called “AsEnumerable” could be defined as an extension method, but this adds some burden to the consumer of the query expression. None of those techniques trigger the query differently in a fundamental way, so any of those can be implemented. Moreover, as discussed in more detail below, a “GetEnumerator” can trigger a termination of a recording or tracking of operations that are stored with a dynamic meta-object.

The “DynamicExpression” is an untyped expression tree representation for dynamically typed expressions, which get reconstructed from the code written by the user. In order to explain this, the implementation of query operators is discussed.

On top of the definition above, a series of query operators as extension methods can be implemented on “IQueryableDynamic.” The signatures differ from those on “IQueryable<T>” in that regular function delegates are utilized rather than expression trees to accept their functional arguments (such as predicate and key selector).

For the sake of brevity, a single operator is depicted, but all the other operators are completely analogous:

```
static class QueryableDynamic
{
public static IQueryableDynamic Where(this IQueryableDynamic source,
Func<dynamic, dynamic> predicate)
{
  return source.Provider.CreateQuery(
  Expression.Dynamic(
  New
DynamicQueryOperatorBinder((MethodInfo)
MethodInfo.GetCurrentMethod( ))
,
  typeof(IQueryableDynamic),
  source.Expression,
  Expression.Constant(predicate)
                                )
                    );
}
```

The implementation pattern is similar to the one found in “IQueryable” or “IQbservable,” calling the source's Provider on the “CreateQuery” method, passing it an expression tree. In the above, the LINQ expression tree API's Dynamic factory method is used to construct the new tree representing the query operator applied to the source with the given predicate.

In order to capture the information about the query operator being applied, a special purpose callsite binder is created called “DynamicQueryOperatorBinder” as shown below:

```
class DynamicQueryOperatorBinder : CallSiteBinder
{
    public DynamicQueryOperatorBinder(MethodInfo method)
    {
        Method = method;
    }
    public MethodInfo Method { get; private set; }
    public override Expression Bind(object[ ] args,
ReadOnlyCollection<ParameterExpression> parameters,
                                        LabelTarget returnLabel)
    {
        ...
    }
}
```

This binder keeps track of the method that was applied in the query expression.

For the implementation of a dynamic SQL query provider, the following skeleton code is employed, which allows execution of the query shown above and inspection of the expression tree being built using the facilities described thus far:

```
class DynamicSqlQuery : IQueryableDynamic, IQueryProviderDynamic
{
    public DynamicSqlQuery( )
    {
        Expression = System.Linq.Expressions.Expression.Dynamic(
            new DynamicQuerySourceBinder( ),
            typeof(DynamicSqlQuery),
            System.Linq.Expressions.Expression.Constant(this)
        );
    }
    public DynamicSqlQuery(DynamicExpression expression)
    {
        Expression = expression;
}
    public DynamicExpression Expression { get; private set; }
    public IQueryProviderDynamic Provider
    {
        get { return this; }
    }
    public IQueryableDynamic CreateQuery(DynamicExpression
expression)
    {
        return new DynamicSqlQuery(expression);
    }
    public IEnumerator<dynamic> GetEnumerator( )
    {
        throw new NotImplementedException( );
    }
}
```

For the sake of brevity, the “DynamicQuerySourceBinder” is omitted which is another implementation of “CallSiteBinder” without a “MethodInfo” parameter as it represents the source node of a query expression. The parameter revealing the source itself is passed through the “Expression.Dynamic” factory call as the last argument “Expression.Constant(this),” so it ends up in the complete tree.

At this point, the query expression can be run shown below, trigger a call to “GetEnumerator” after the query expression was built by means of calls to methods like “Where,” “OrderByDescending,” “Select” and “Take:”

```
IQueryableDynamic products = new DynamicSqlQuery( );
var res = (from p in products
                where p.Price > 100
                orderby p.Price descending
                select new { p.Name, p.Price })
                .Take(10);
foreach (var p in res)
    Console.WriteLine(p.Name + “ costs ” + p.Price);
```

As a result, an expression tree is created as follows:

```
.Dynamic DynamicQueryOperatorBinder(
    .Dynamic DynamicQueryOperatorBinder(
        .Dynamic DynamicQueryOperatorBinder(
            .Dynamic DynamicQueryOperatorBinder(
                .Dynamic DynamicQuerySourceBinder
(.Constant<DynamicSqlQuery>(DynamicSqlQuery)),
.Constant<System.Func\grave{ }2[System.Object,System.Object]>(System.Func\grave{ }2
[System.Object,System.Object])),.Constant<System.Func\grave{ }2
[System.Object,System.Object]>(System.Func\grave{ }2[System.Object,
System.Object])),.Constant<System.Func\grave{ }2[System.Object,
System.Object]>(System.Func\grave{ }2[System.Object,System.Object])),10)
```

Notice from the above, the dynamically typed functions for predicates, key selectors, etc. are illustrated as “Func<object, object>” delegates because the general-purpose programming language dynamic type is erased away into “System.Object.”

The query expression is depicted at macroscopic operator-level structure captured in a tree. The reconstruction of the individual nodes is discussed. In particular, a data representation of the “Func<object, object” nodes can be generated rather than a code representation. To achieve this, the expression tree and all the “dynamic sites” do the reconstruction.

In the running example, the user implicitly wrote lambda expressions, for instance, “p =>p.Price>100” in the larger query expression (in this sample, for the where clause predicate). Since the parameter “p” is typed to be “dynamic”, the compiler has constructed dynamic call sites to resolve the call to Price, which on its turn returns a dynamic object that introduces another call site used for the >100 comparison. Symbolically and as an example, this can be stated as follows:
CSharp.LargerThan(CSharp.GetMember(p, “Price”), 100)

The hypothetical “CSharp” class can be the runtime version of the general-purpose programming language compiler that applies resolution and checking logic at runtime. So, if the object passed to parameter “p” happens to have a Price object, the “GetMember” call would succeed. If the result of obtaining Price is an object that permits comparison with 100 using the >operator, “LargerThan” would succeed. Finally, the result of the function call would be the result of the dynamically resolved call “p.Price>100.”

For instance, any of those resolution calls can be intercepted by implementing a dynamic meta-object. Following the above example, two operations are illustrated below:

```
class DynamicParameter : DynamicObject
{
    public override bool TryGetMember(GetMemberBinder binder, out
object result)
    {
        result = new DynamicMember(this, binder.Name);
        return true;
    }
}
class DynamicMember : DynamicObject
{
    private object left;
    private string name;
    public DynamicMember(object left, string name)
    {
        this.left = left;
        this.name = name;
    }
    public override bool TryBinaryOperation(BinaryOperationBinder
binder, object arg,
        out object result)
    {
        result = new DynamicOperator(binder.Operation, this, arg);
        return true;
    }
}
class DynamicOperator : DynamicObject
{
    private ExpressionType operation;
    private object left;
    private object right;
    public DynamicOperator(ExpressionType operation, object left,
object right)
    {
        this.operation = operation;
        this.left = left;
        this.right = right;
    }
}
```

A plurality of those objects is made to represent the various dynamic operations that are permitted. For example, to resolve the predicate “p.Price>100”, an instance of “DynamicParameter” is fed to the predicate's argument. This causes the programming language generated dynamic call site to look out for a “GetMember” operation, which is found through the DynamicObject's override for “TryGetMember.” In there, the name of the member (“Price”) is extracted and a “DynamicMember” node is created which is returned through the output parameter. By returning true, the call site is told of success in resolving the operation. Next, the “>100” call site looks out for an implementation of the binary operation “GreaterThan,” which it can resolve through “TryBinaryOperation.” And so on (for example, the “DynamicOperator” type could implement “TryBinaryOperation” to allow && or∥ predicates, etc.) and so forth.

The “DynamicExpression” based expression tree can be discussed and a “DynamicParameter” object can be fed to all the unknown functions (such as Where's predicate, Select's key selector, among others). It is to be appreciated that the mechanics of the expression tree visitation can be omitted to accomplish the rewrite, but the result looks as follows in a textual manner:

```
.Dynamic DynamicQueryOperatorBinder(
    .Dynamic DynamicQueryOperatorBinder(
        .Dynamic DynamicQueryOperatorBinder(
            .Dynamic DynamicQueryOperatorBinder(
                .Dynamic
DynamicQuerySourceBinder(.Constant<DynamicSqlQuery>
(DynamicSqlQuery)),.Constant<DynamicFunc[DynamicParameter,
DynamicOperator]>(p =>p.Price>100)),.Constant<DynamicFunc
[DynamicParameter,DynamicMember]>(p => p.Price)),
.Constant<DynamicFunc[DynamicParameter,DynamicNew]>(p=> new
{ p.Price,p.Name })),10)
```

The expression tree contains all the information needed to execute the query: the “DynamicOperatorBinder” nodes contain the “MethodInfo” objects representing the query operator methods used, the “DynamicQuerySourceBinder” points to the query source (here a “DynamicSqlQuery” object, which could by itself be parameterized on a table name), and the “DynamicExpression” nodes now contain expression representation for the predicates, key selectors, etc.

One of the properties of programming language dynamic is the contagious dynamic typing that result. The following code used to consume the results of the query shown earlier has a loop variable “p” that's also dynamically typed. The type of this variable results from “GetEnumerator” whose return type is “IEnumerator<dynamic>.” Any other means for the query to get executed would get a similar treatment where the resulting objects are dynamically typed (e.g., an “AsEnumerable” or “AsObservable” method would return “IEnumerable<dynamic>” or “IObservable<dynamic>”). Take the following for instance:

foreach (var p in res)
Console.WriteLine(p.Name + “ costs ” + p.Price);

Again, the call sites generated for p.Name and p.Price are going to consult the implementation of “p” for a means to get those members called “Name” and “Price.” The query provider is responsible to produce results whose “GetMember “calls will succeed for the queried members (assuming those exist, that is).

For example, the DynamicSqlQuery's GetEnumerator method can do the following:

```
public IEnumerator<dynamic> GetEnumerator( )
{
    List<string> columns;
    string sql = TranslateQuery(Expression, out columns);
    // Run the query against a SQL Server connection and fetch
results.
    SqlDataReader res = ExecuteQuery(sql);
    while (res.Read( ))
    {
        IDictionary<string, object> record = new ExpandoObject( );
        foreach (string column in columns)
            record[column] = res[column];
        yield return record;
    }
}
```

In the above, “TranslateQuery” is what a regular query provider would do: translating the given query expression by visiting the expression tree and turning it into T-SQL statements. It is to be appreciated that an output parameter communicates back all of the columns that are fetched by the query, e.g., through a SELECT clause. Other means to achieve this could be, for instance, when SELECT * is used and the column names have to be discovered dynamically at runtime. Based on such information, a dynamic object is returned to the caller. In this case, “ExpandoObject” is used which is a “DynamicObject” implementation with a “TryGetMember” method that performs a string-to-object dictionary lookup. All the available columns are copied from the “SqlDataReader” into the expando. Alternative approaches include the creation of a whole new “DynamicObject” implementation, e.g., to implement more flexibility with regards to column name casing, whitespace, etc.

The aforementioned systems, architectures, environments, and the like have been described with respect to interaction between several components. It should be appreciated that such systems and components can include those components or sub-components specified therein, some of the specified components or sub-components, and/or additional components. Sub-components could also be implemented as components communicatively coupled to other components rather than included within parent components. Further yet, one or more components and/or sub-components may be combined into a single component to provide aggregate functionality. The components may also interact with one or more other components not specifically described herein for the sake of brevity, but known by those of skill in the art.

Furthermore, as will be appreciated, various portions of the disclosed systems above and methods below can include or consist of artificial intelligence, machine learning, or knowledge or rule-based components, sub-components, processes, means, methodologies, or mechanisms (e.g., support vector machines, neural networks, expert systems, Bayesian belief networks, fuzzy logic, data fusion engines, classifiers . . . ). Such components, inter alia, can automate certain mechanisms or processes performed thereby to make portions of the systems and methods more adaptive as well as efficient and intelligent. By way of example and not limitation, the transform component 110 or one or more sub-components thereof can employ such mechanisms to efficiently determine or otherwise infer identification and transformation of dynamic call on dynamic data within general-purpose programming languages to create a structure representative of such based upon a function call with a dynamic meta-object.

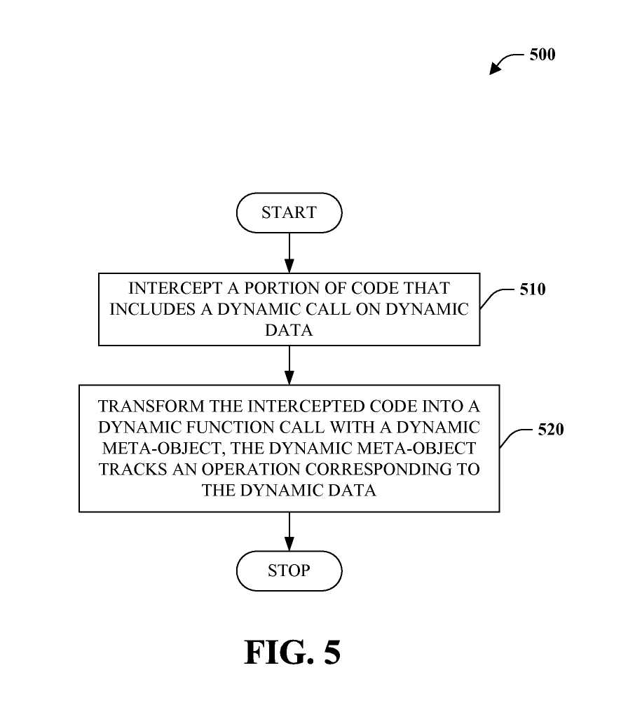

In view of the exemplary systems described supra, methodologies that may be implemented in accordance with the disclosed subject matter will be better appreciated with reference to the flow charts of FIGS. 5-7. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methods described hereinafter.

Turning to FIG. 5, a method 500 of transforming a dynamic call on dynamic data is depicted. At reference numeral 510, a portion of code that includes a dynamic call on dynamic data can be intercepted. By way of example and not limitation, the dynamic call can be any suitable method or function that references data from a data source that has an unknown schema. At reference numeral 520, the intercepted code can be transformed into a dynamic function call with a dynamic meta-object in which the dynamic meta-object tracks an operation corresponding to the dynamic data. By transforming the dynamic call on dynamic data to a dynamic function call with a dynamic meta-object, a general-purpose programming language compiler will not generate an error.

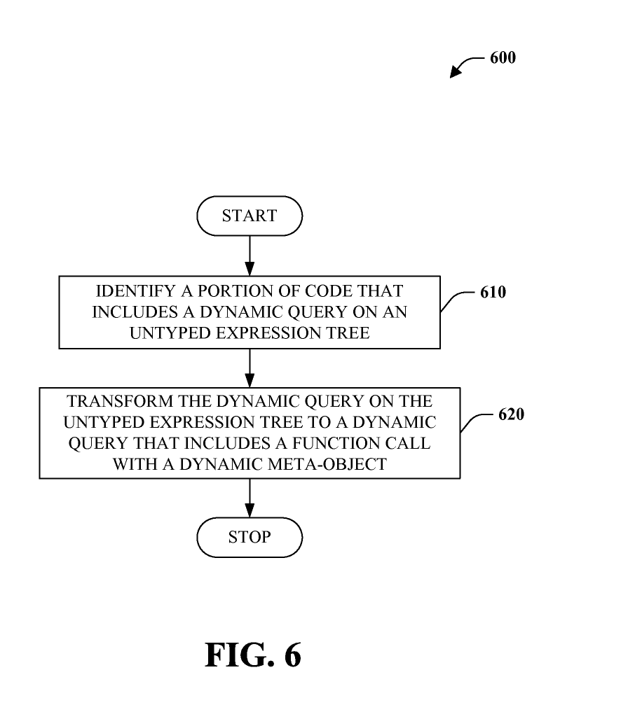

FIG. 6, a method 600 of transforming a dynamic query with an untyped expression tree is illustrated. At reference numeral 610, a portion of code that includes a dynamic query with an expression tree (e.g., a code object representation) that includes an untyped parameter can be identified. In general, any suitable portion of code that includes a dynamic call on dynamic data can be identified. For instance, a dynamic query with an expression tree or any other code object representation that includes at least one untyped or dynamic parameter can be identified. At reference numeral 620, the dynamic query with the untyped expression tree can be transformed to a dynamic query that includes a function call with a dynamic meta-object. In other words, a structure representative of the untyped expression tree (e.g., expression tree that includes an untyped parameter or untyped operation that references untyped data) is created based upon each function call with a dynamic meta-object in which the dynamic meta-object tracks each operation corresponding to the untyped expression tree. In a more general example, any identified dynamic call on dynamic data can be transformed into a dynamic call with at least one function call with a dynamic meta-object in which the dynamic meta-object tracks operation(s) associated with the dynamic data.

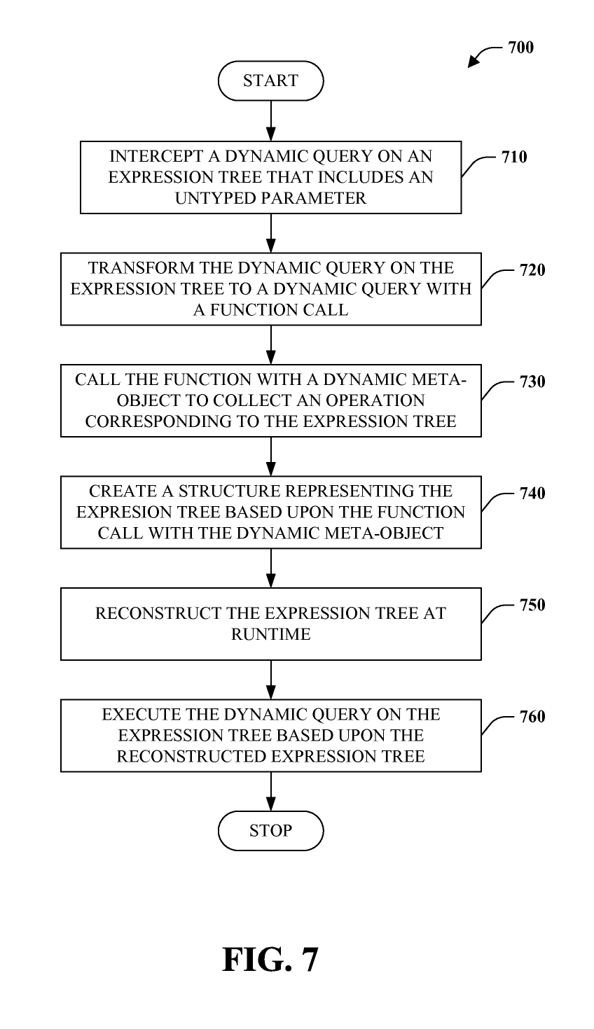

FIG. 7 is a flow chart diagram 700 of creating a structure representative of an untyped expression tree for employment in a query. At reference numeral 710, a dynamic query with an expression tree that includes an untyped parameter can be intercepted. At reference numeral 720, the dynamic query with the expression tree can be transformed to a dynamic query with a function call. At reference numeral 730, the function can be called with a dynamic meta-object to collect an operation corresponding to the expression tree. At reference numeral 740, a structure representing the expression tree can be created based upon the function call with the dynamic meta-object. At reference numeral 750, the expression tree can be reconstructed at runtime based upon the structure. At reference numeral 760, the dynamic query can be executed with the expression tree based upon the reconstructed expression tree.

As used herein, the terms “component” and “system,” as well as forms thereof are intended to refer to a computer-related entity, either hardware, a combination of hardware and software, software, or software in execution. For example, a component may be, but is not limited to being, a process running on a processor, a processor, an object, an instance, an executable, a thread of execution, a program, and/or a computer. By way of illustration, both an application running on a computer and the computer can be a component. One or more components may reside within a process and/or thread of execution and a component may be localized on one computer and/or distributed between two or more computers.

The word “exemplary” or various forms thereof are used herein to mean serving as an example, instance, or illustration. Any aspect or design described herein as “exemplary” is not necessarily to be construed as preferred or advantageous over other aspects or designs. Furthermore, examples are provided solely for purposes of clarity and understanding and are not meant to limit or restrict the claimed subject matter or relevant portions of this disclosure in any manner It is to be appreciated a myriad of additional or alternate examples of varying scope could have been presented, but have been omitted for purposes of brevity.

As used herein, the term “inference” or “infer” refers generally to the process of reasoning about or inferring states of the system, environment, and/or user from a set of observations as captured via events and/or data. Inference can be employed to identify a specific context or action, or can generate a probability distribution over states, for example. The inference can be probabilistic - that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

Furthermore, to the extent that the terms “includes,” “contains,” “has,” “having” or variations in form thereof are used in either the detailed description or the claims, such terms are intended to be inclusive in a manner similar to the term “comprising” as “comprising” is interpreted when employed as a transitional word in a claim.

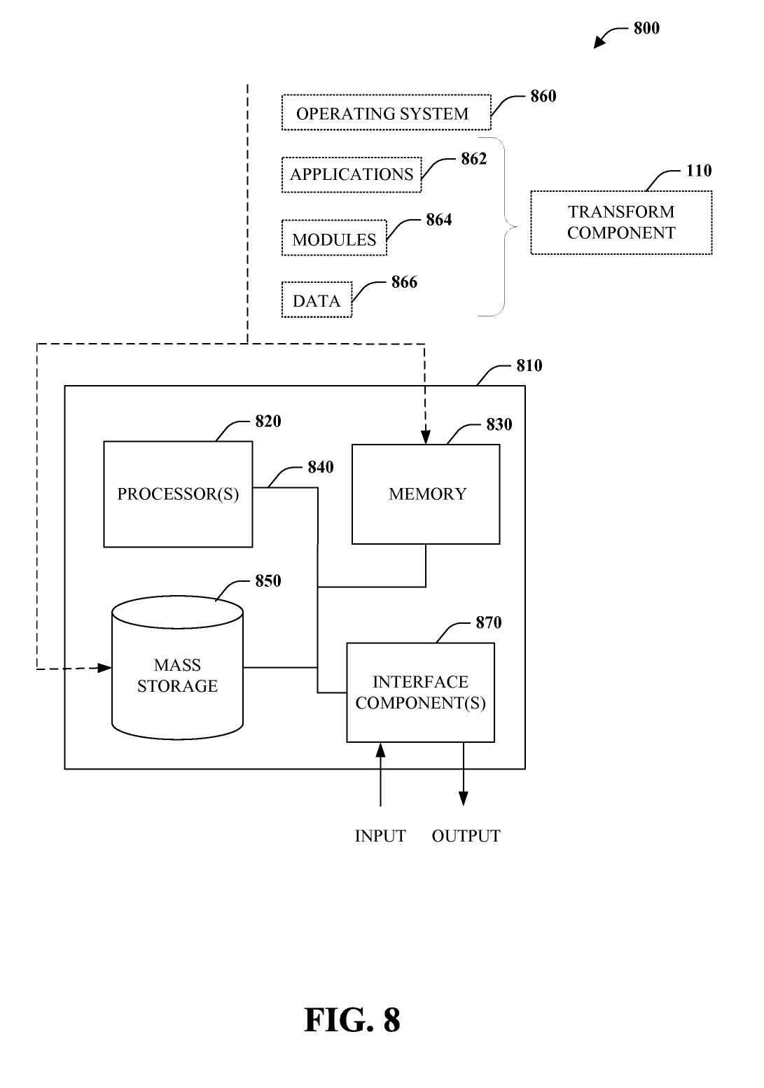

In order to provide a context for the claimed subject matter, FIG. 8 as well as the following discussion are intended to provide a brief, general description of a suitable environment in which various aspects of the subject matter can be implemented. The suitable environment, however, is only an example and is not intended to suggest any limitation as to scope of use or functionality.

While the above disclosed system and methods can be described in the general context of computer-executable instructions of a program that runs on one or more computers, those skilled in the art will recognize that aspects can also be implemented in combination with other program modules or the like. Generally, program modules include routines, programs, components, data structures, among other things that perform particular tasks and/or implement particular abstract data types. Moreover, those skilled in the art will appreciate that the above systems and methods can be practiced with various computer system configurations, including single-processor, multi-processor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. Aspects can also be practiced in distributed computing environments where tasks are performed by remote processing devices that are linked through a communications network. However, some, if not all aspects of the claimed subject matter can be practiced on stand-alone computers. In a distributed computing environment, program modules may be located in one or both of local and remote memory storage devices.

With reference to FIG. 8, illustrated is an example general-purpose computer 810 or computing device (e.g., desktop, laptop, server, hand-held, programmable consumer or industrial electronics, set-top box, game system . . . ). The computer 810 includes one or more processor(s) 820, memory 830, system bus 840, mass storage 850, and one or more interface components 870. The system bus 840 communicatively couples at least the above system components. However, it is to be appreciated that in its simplest form the computer 810 can include one or more processors 820 coupled to memory 830 that execute various computer executable actions, instructions, and or components.

The processor(s) 820 can be implemented with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. The processor(s) 820 may also be implemented as a combination of computing devices, for example a combination of a DSP and a microprocessor, a plurality of microprocessors, multi-core processors, one or more microprocessors in conjunction with a DSP core, or any other such configuration.

The computer 810 can include or otherwise interact with a variety of computer-readable media to facilitate control of the computer 810 to implement one or more aspects of the claimed subject matter. The computer-readable media can be any available media that can be accessed by the computer 810 and includes volatile and nonvolatile media and removable and non-removable media. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to memory devices (e.g., random access memory (RAM), read-only memory (ROM), electrically erasable programmable read-only memory (EEPROM) . . . ), magnetic storage devices (e.g., hard disk, floppy disk, cassettes, tape . . . ), optical disks (e.g., compact disk (CD), digital versatile disk (DVD) . . . ), and solid state devices (e.g., solid state drive (SSD), flash memory drive (e.g., card, stick, key drive . . . ) . . . ), or any other medium which can be used to store the desired information and which can be accessed by the computer 810.

Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

Memory 830 and mass storage 850 are examples of computer-readable storage media. Depending on the exact configuration and type of computing device, memory 830 may be volatile (e.g., RAM), non-volatile (e.g., ROM, flash memory . . . ) or some combination of the two. By way of example, the basic input/output system (BIOS), including basic routines to transfer information between elements within the computer 810, such as during start-up, can be stored in nonvolatile memory, while volatile memory can act as external cache memory to facilitate processing by the processor(s) 820, among other things.

Mass storage 850 includes removable/non-removable, volatile/non-volatile computer storage media for storage of large amounts of data relative to the memory 830. For example, mass storage 850 includes, but is not limited to, one or more devices such as a magnetic or optical disk drive, floppy disk drive, flash memory, solid-state drive, or memory stick.

Memory 830 and mass storage 850 can include, or have stored therein, operating system 860, one or more applications 862, one or more program modules 864, and data 866. The operating system 860 acts to control and allocate resources of the computer 810. Applications 862 include one or both of system and application software and can exploit management of resources by the operating system 860 through program modules 864 and data 866 stored in memory 830 and/or mass storage 850 to perform one or more actions. Accordingly, applications 862 can turn a general-purpose computer 810 into a specialized machine in accordance with the logic provided thereby.

All or portions of the claimed subject matter can be implemented using standard programming and/or engineering techniques to produce software, firmware, hardware, or any combination thereof to control a computer to realize the disclosed functionality. By way of example and not limitation, the transform component 110 can be, or form part, of an application 862, and include one or more modules 864 and data 866 stored in memory and/or mass storage 850 whose functionality can be realized when executed by one or more processor(s) 820, as shown.

In accordance with one particular embodiment, the processor(s) 820 can correspond to a system-on-a-chip (SOC) or like architecture including, or in other words integrating, both hardware and software on a single integrated circuit substrate. Here, the processor(s) 820 can include one or more processors as well as memory at least similar to processor(s) 820 and memory 830, among other things. Conventional processors include a minimal amount of hardware and software and rely extensively on external hardware and software. By contrast, an SOC implementation of processor is more powerful, as it embeds hardware and software therein that enable particular functionality with minimal or no reliance on external hardware and software. For example, the transform component 110, and/or associated functionality can be embedded within hardware in a SOC architecture.

The computer 810 also includes one or more interface components 870 that are communicatively coupled to the system bus 840 and facilitate interaction with the computer 810. By way of example, the interface component 870 can be a port (e.g., serial, parallel, PCMCIA, USB, FireWire . . . ) or an interface card (e.g., sound, video . . . ) or the like. In one example implementation, the interface component 870 can be embodied as a user input/output interface to enable a user to enter commands and information into the computer 810 through one or more input devices (e.g., pointing device such as a mouse, trackball, stylus, touch pad, keyboard, microphone, joystick, game pad, satellite dish, scanner, camera, other computer . . . ). In another example implementation, the interface component 870 can be embodied as an output peripheral interface to supply output to displays (e.g., CRT, LCD, plasma . . . ), speakers, printers, and/or other computers, among other things. Still further yet, the interface component 870 can be embodied as a network interface to enable communication with other computing devices (not shown), such as over a wired or wireless communications link.

What has been described above includes examples of aspects of the claimed subject matter. It is, of course, not possible to describe every conceivable combination of components or methodologies for purposes of describing the claimed subject matter, but one of ordinary skill in the art may recognize that many further combinations and permutations of the disclosed subject matter are possible. Accordingly, the disclosed subject matter is intended to embrace all such alterations, modifications, and variations that fall within the spirit and scope of the appended claims.

What is claimed is:

1. A method of facilitating dynamic querying, comprising:
employing at least one processor configured to execute computer-executable instructions stored in memory to perform the following acts:
transforming a dynamic call on untyped data to a function call with a dynamic meta-object.

2. The method of claim 1, the untyped data is referenced by a code object representation.

3. The method of claim 2 further comprises collecting an operation executed based upon the code object representation with the dynamic meta-object.

4. The method of claim 3, building a structure representative of the code object representation based upon the dynamic meta-object and collected operation.

5. The method of claim 4, executing the function call with the dynamic meta-object at runtime to reconstruct the code object representation based upon function call with the dynamic meta-object.

6. The method of claim 5, executing the query and the function call with the dynamic meta-object at runtime.

7. The method of claim 6 further comprises building the code object representation based upon the structure representative of the code object representation at runtime.

8. The method of claim 7, resolving the query and the function call with the dynamic meta-object based upon a data source at runtime, the data source does not include a schema.

9. The method of claim 8, the query is not mapped to a static element within the data source.

10. A system that facilitates executing a dynamic function call, comprising:
a processor coupled to a memory, the processor configured to execute the following computer-executable components stored in the memory:
a first component configured to intercept a dynamic call on dynamic data; and
a second component configured to generate a structure that records an operation invoked by the call.

11. The system of claim 10, the structure includes a function call with a dynamic meta-object.

12. The system of claim 11, the dynamic call forms at least part of query.

13. The system of claim 12 the dynamic data is a code object representation that includes an untyped parameter.

14. The system of claim 11, the dynamic meta-object tracks an operation corresponding to the dynamic data.

15. The system of claim 14, the dynamic call is executed with the structure at runtime based upon the operation stored with the dynamic meta-object.

16. The system of claim 11 further comprising a third component configured to identify the function call for each predicate in the dynamic call.

17. The system of claim 16 further comprises a fourth component configured to inject a dynamic meta-object into the function call for each predicate in the dynamic call to record an operation included within the dynamic data.

18. The system of claim 11, the structure is reconstructed at runtime based upon the dynamic meta-object for each predicate to create the dynamic data.

19. A method, comprising:
employing at least one processor configured to execute computer-executable instructions stored in memory to perform the following acts:
generating a structure representing a code object representation that includes an untyped parameter.

20. The method of claim 19, generating the structure including a function call with a dynamic meta-object that tracks an operation corresponding to the code object representation, the code object representation is an expression tree.
